(19) United States
(12) Patent Application Publication
(10) Pub. No.: US 2017/0030534 A1
(43) Pub. Date: Feb. 2, 2017

(54) Wire Structure For Decorative Light String

(71) Applicant: Kuo-Wei Pan, Hsinchu City (TW)

(72) Inventor: Kuo-Wei Pan, Hsinchu City (TW)

(21) Appl. No.: 14/811,838

(22) Filed: Jul. 29, 2015

(51) Int. Cl. F21S 4/10

(52) U.S. Cl. CPC F21S 4/10

(57) ABSTRACT

Disclosed is a wire structure for a decorative light string; a wire body used in the entire light string set is adopted with an insulating outer jacket covering a bundle of metal conductive filaments and a bundle of light and nonconductive non-metallic filaments at the same time to form an wire structure with a diameter close to the one of a wire of a general conventional decorative light string, thereby allowing the wire to increase the tensile strength substantially at a lower cost only increasing the weight and diameter thereof a little bit so as to increase the practicability of the wire of the decorative light string of the present invention.

### TECHNICAL FIELD OF THE INVENTION

The present invention relates to a decorative light string structure, such as Christmas light, curtain light or net light, and more particularly to a wire structure for such kind of decorative light.

### DESCRIPTION OF THE PRIOR ART

The decorative light string of the present invention is mainly referred to, for example, a Christmas light, curtain light, icicle light or net light used for decoration. Such light string is mostly composed of a plurality of light series, and the wires used for the light strings are always adopted with thin wires with a smaller diameter. It is because the wires are thin, the tensile strength thereof are relatively weak, especially, the curtain light string shown in FIGS. 1 and 2. Such kind of light string is a light string formed by a transverse wire 1 combined with a plurality of light series 4 each of which is constituted by a vertical wire 2 and light bulbs. The use of light string mentioned above is holding the two ends of the transverse wire on respective hangers 5, allowing the plurality of light series 4 to hang down vertically, which is formed like a curtain.

Furthermore, as FIG. 2 shows, the transverse wire 1 would be pulled down largely to form a downward curve because of the total weight of the vertical light series 4 during the suspension of the curtain light string mentioned above. In addition, if each of the light series 4 is too long, the vertical wires of the light series 4 may also be subject to a larger pull force because of the larger weight of the wires themselves and bulbs. However, the wires used in such light strings, as FIG. 3 shows, are thin wires with a smaller diameter formed by covering a bundle of metal conductive filaments 20 with an insulating outer jacket 10, where the metal conductive filaments 20 are made from copper, and the whole bundle of metal conductive filaments 20 is rather small in diameter, with the covering insulating outer jacket 10 being also thinner in thickness, such that the tensile strength of the whole wire is relatively weaker. As a result, it is very possible to cause the metal conductive filaments to be broken, and therefore to break down the entire decorative light string set after a long time hanging thereof To solve the problem, the widening of the diameter of the whole bundle of the metal conductive filaments 20 to thicken the wire might increase the tensile strength, but the metal conductive filaments 20 made from copper are very high is cost. Moreover, the power voltage used for the decorative light string is not high such that it is unnecessary to use the wires with a larger diameter. Therefore, the widening of the metal conductive filament 20 to increase the tensile strength is nothing but waste the resources and cost; it is not an ideal way to solve the problem mentioned above.

### SUMMARY OF THE INVENTION

To increase the tensile strength of the wire of a decorative light string without increasing the cost too much, thereby solving the drawback of the weak tensile strength of the wires of conventional decorative light strings, the present invention is proposed.

The present invention is related to a decorative light string structure, such as Christmas light, curtain light or net light, and mainly performs an improvement on the wire structure of a decorative light string such as Christmas light, curtain light or net light, it is characterized in that a wire body used in the entire light string set is adopted with an insulating outer jacket covering a bundle of metal conductive filaments and a bundle of lightly-textured and nonconductive non-metallic filaments at the same time to form an wire structure with a diameter close to the one of a wire of a general conventional light string, thereby allowing the wire to increase the tensile strength substantially at a lower cost only increasing the weight and diameter thereof a little bit so as to increase the practicability of the wire of the decorative light string of the present invention.

### BRIEF DESCRIPTION OF THE DRAWINGS

FIG. 1 is a schematic view of a structure arrangement of a decorative light string which is of curtain type;

FIG. 2 is a schematic view of a decorative light string which is of curtain type in a use state;

FIG. 3 is a schematic view of a wire structure of a conventional decorative light string;

FIG. 4 is a schematic view of a wire structure of a decorative light string according to the present invention; and

FIG. 5 is a schematic view of a preferred embodiment of a wire structure of a decorative light string according to the present invention.

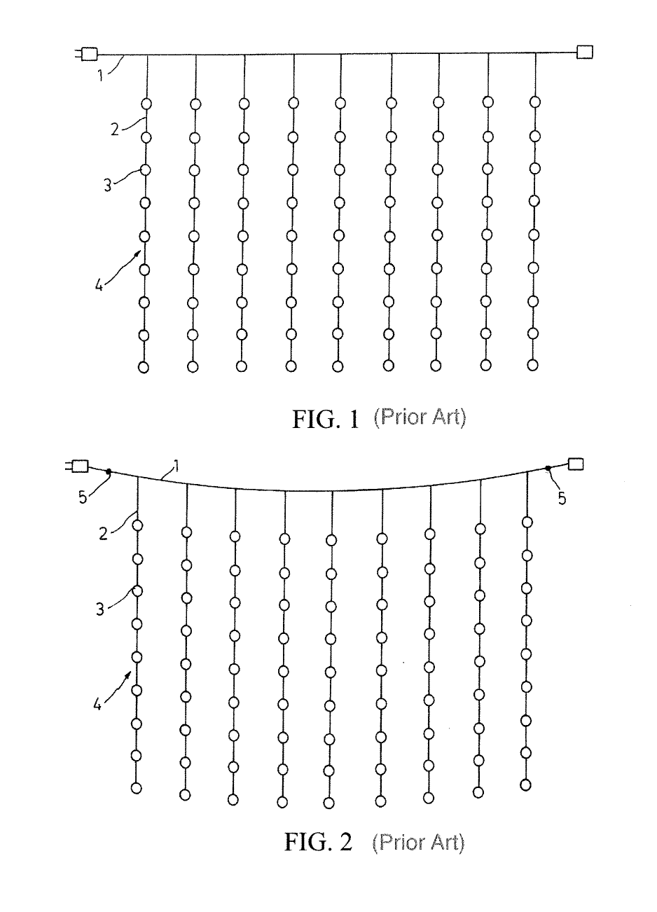

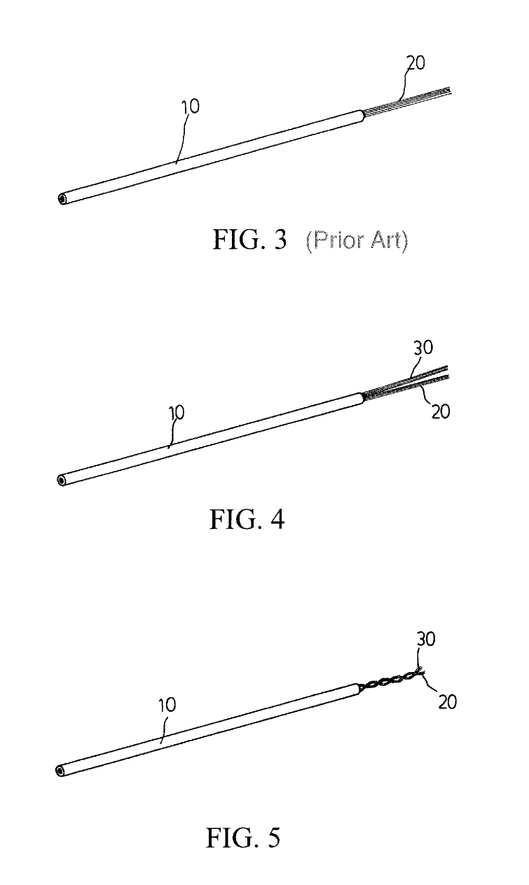

### DETAILED DESCRIPTION OF THE PREFERRED EMBODIMENTS

Referring to FIG. 4, the wire structure of a decorative light string according to the present invention is a wire with a diameter close to the one of a wire of conventional decorative light strings formed by covering a bundle of metal conductive filaments 20 and a bundle of lightly-textured and nonconductive non-metallic filaments 30 with an insulating outer jacket 10 at the same time, where the whole bundle of metal conductive filaments 20 is combined into one body with the whole bundle of nonconductive non-metallic filaments 30 in parallel thereto, thereby allowing the wire to increase the tensile strength substantially at a lower cost only increasing the weight and diameter thereof a little bit so as to increase the practicability of the wire of the decorative light string of the present invention.

Referring to FIG. 5, the wire structure of a decorative light string according to the present invention is a wire with a diameter close to the one of a wire of conventional decorative light strings formed by covering a bundle of metal conductive filaments 20 and a bundle of lightly-textured and nonconductive non-metallic filaments 30 with an insulating outer jacket 10 at the same time, where the whole bundle of metal conductive filaments 20 and the whole bundle of nonconductive non-metallic filaments 30 are wound around each other to combine into one body.

1. A wire structure for a decorative light string, comprising a bundle of metal conductive filaments and a bundle of nonconductive non-metallic filaments, which are collectively covered and enclosed with an insulating outer jacket such that the bundle of metal conductive filaments being is substantially parallel to the bundle of non-conductive non-metallic filaments and is located outside the bundle of non-conductive non-metallic filaments.

2. A wire structure for a decorative light string, comprising a bundle of metal conductive filaments and a bundle of nonconductive non-metallic filaments, which are collectively covered and enclosed with an insulating outer jacket such that the bundle of metal conductive filaments and the bundle of nonconductive non-metallic filaments are wound around each other in the form of a double helix and the bundle of metal conductive filaments is located outside the bundle of non-conductive non-metallic filaments.
